(19) United States
(12) Patent Application Publication
(10) Pub. No.: US 2003/0214707 A1
(43) Pub. Date: Nov. 20, 2003

(54) Scanning microscope and beam deflection device

(75) Inventor: Johann Engelhardt, Bad Schoenborn (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Heidelberg GmbH, Mannheim (DE)

(21) Appl. No.: 10/439,742

(22) Filed: May 16, 2003

(30) Foreign Application Priority Data
May 18, 2002 (DE) DE 202 07 817.5

(51) Int. Cl. G02B 21/06

(52) U.S. Cl. 359/385; 359/368; 359/390

(57) ABSTRACT

A scanning microscope has a light source that generates a light beam for illumination of a specimen, and has a beam deflection device with which the light beam can be guided over the specimen. The beam deflection device contains at least one rotatable unit having at least one reflecting mirror. A compensation element that executes a motion equal and opposite to that of the rotatable unit is arranged in such a way that it at least partially compensates for the moment of inertia of the rotatable unit.

### CROSS REFERENCE TO RELATED APPLICATIONS

Priority is claimed to German utility model application 202 07 817.5, which is hereby incorporated by reference herein.

### FIELD OF THE INVENTION

The invention concerns a scanning microscope and a confocal scanning microscope.

The invention further concerns a beam deflection device for a scanning microscope.

### BACKGROUND OF THE INVENTION

In scanning microscopy, a specimen is illuminated with a light beam in order to observe the detected light emitted, as reflected or fluorescent light, from the specimen. The focus of an illuminating light beam is moved in a specimen plane by means of a controllable beam deflection device, generally by tilting two mirrors; the deflection axes are usually perpendicular to one another, so that one mirror deflects in the X direction and the other in the Y direction. Tilting of the mirrors is brought about, for example, by means of galvanometer positioning elements. The power level of the detected light coming from the specimen is measured as a function of the position of the scanning beam. The positioning elements are usually equipped with sensors to ascertain the present mirror position.

In confocal scanning microscopy specifically, a specimen is scanned in three dimensions with the focus of a light beam.

A confocal scanning microscope generally comprises a light source, a focusing optical system with which the light of the source is focused onto an aperture (called the “excitation pinhole”), a beam splitter, a beam deflection device for beam control, a microscope optical system, a detection pinhole, and the detectors for detecting the detected or fluorescent light. The illuminating light is coupled in via a beam splitter. The fluorescent or reflected light coming from the specimen travels back through the beam deflection device to the beam splitter, passes through it, and is then focused onto the detection pinhole behind which the detectors are located. Detected light that does not derive directly from the focus region takes a different light path and does not pass through the detection pinhole, so that a point datum is obtained which results, by sequential scanning of the specimen, in a three-dimensional image. A three-dimensional image is usually achieved by acquiring image data in layers.

German Unexamined Application DE 43 22 694 A1 describes a confocal microscope containing a scanner arrangement in which the deflection arrangement along the X axis contains two resonance scanners that oscillate about parallel axes at different frequencies, one of which is a harmonic of the other. As a consequence thereof, scanning along the X axis can be performed almost linearly even though it occurs in conjunction with a resonance, and advantages associated with the rapidity of resonance systems can therefore be achieved. A galvanometer rotates the housing of one of the resonance scanners about its axis in order to achieve an X-axis pivoting function.

German Patent DE 196 54 210 C2 discloses an optical arrangement for scanning a beam in two axes lying substantially perpendicular to one another, in particular for use in confocal laser scanning microscopes. In order to eliminate serious aberrations, the optical arrangement, which has two mirrors rotatable by means of respective drives about mutually perpendicular axes (X axis and Y axis), is characterized in that one of the two mirrors has a further mirror associated nonrotatably with it in a predefined angular position, so that the mirrors associated with one another (first and second mirrors) rotate together about the Y axis and thereby rotate the beam about a rotation point that lies on the rotation axis (X axis) of the third mirror which rotates alone.

German Unexamined Application DE 42 05 725 A1 discloses a galvanometer that encompasses a cylindrical magnetic rotor which is polarized into two substantially semi-cylindrical poles on opposite sides of its axis. A rotor is shown that comprises a thin-walled torque-absorbing sleeve which surrounds at least a portion of the magnet and is joined to the output shaft and to the magnet. An attachment means anchors the coil body to the shell in order to prevent relative rotation therebetween.

The known scanning microscopes have the disadvantage, especially at high scanning rates, that because of the inertia of the moving components of the beam deflection device, troublesome vibrations and mechanical oscillations are transferred therefrom to the scanning microscope and the specimen. This results not only in degraded image acquisition but also in damage to the specimen when micro-instruments protruding into the specimen—such as micropipettes, microelectrodes, or patch clamps—are used.

Galvanometers, such as e.g. the galvanometer known from the aforementioned DE 42 05 725 A1, have a sleeve (having the greatest possible inertia) that is intended to absorb the torque generated by the rotor. This is not sufficient, however, if further protruding high-inertia elements are attached to the rotor. Arrangements for beam deflection such as those known from German Patent DE 196 54 210 C2 already cited are, in particular, unusable at high line scanning rates because of the mirror carrier which protrudes a great distance from the rotation axis.

### SUMMARY OF THE INVENTION

It is therefore an object of the present invention to describe a scanning microscope in which mechanical disturbances and vibrations caused by the beam deflection device are eliminated or at least reduced.

The present invention provides a scanning microscope comprising:

a light source that generates a light beam for illumination of a specimen

a beam deflection device with which the light beam can be guided over the specimen, the beam deflection device containing at least one rotatable unit having at least one reflecting mirror,

a compensation element that executes a motion equal and opposite to that of the rotatable unit which is arranged in such a way that it at least partially compensates for the moment of inertia of the rotatable unit.

A further object of the invention is to describe a beam deflection device for a scanning microscope that for the most part transfers no troublesome mechanical excursions or vibrations to the scanning microscope.

The present invention also provides a beam deflection device with which a light beam can be guided over a specimen, the beam deflection device comprising: at least one rotatable unit having at least one reflecting mirror, a compensation element that executes a motion equal and opposite to that of the rotatable unit is arranged in such a way that it at least partially compensates for the moment of inertia of the rotatable unit.

The invention has the advantage that the risk of damage to the specimen is decreased, and that good image quality is guaranteed even at high scanning rates.

In a preferred embodiment, the reflecting mirror is tiltable or pivotable about a first axis. In another embodiment, a housing within which the reflection mirror is positioned is mounted on the rotation shaft of the drive. A pivot arm can also be provided. The rotatable unit can contain, for example, a mirror substrate, or also a more complex holder, carrier, or retaining arm.

In a preferred embodiment, the compensation element compensates at least partially for the moment of inertia of further movable components. The further movable components can include drive elements of the scanning microscope or of the beam deflection device, for example of a galvanometer or motor, or components for energy transfer.

In a preferred embodiment, the drive pivots a first reflecting mirror, arranged on a pivot arm, about a rotation axis. A second reflecting mirror, which is equipped with a separate drive and is pivotable about a further rotation axis perpendicular to the rotation axis, serves, in the context of meander-shaped scanning of the specimen, for scanning the scanning points within the lines (X deflection), while the first reflecting mirror serves to scan the lines (Y deflection). The rotation shaft of the drive is coupled via a largely zero-backlash linkage to the compensation element, which is embodied e.g. as a solid cylinder and has the same moment of inertia as the first and the second reflection mirror together with their mounts and pivot arms. Because of the coupling, the compensation element rotates in equal and opposite fashion about a second axis that is parallel to the first axis. The compensation element can also be embodied as a pivot anchor that pivots about the second axis.

In a preferred embodiment, the compensation element and the rotatable unit are mechanically coupled to one another with belts that transfer the drive energy. This embodiment is particularly efficient because energy transfer is accomplished in largely zero-backlash fashion, which is advantageous especially upon reversal of the direction of motion. In this form, the drive also drives the compensation element. It is also possible for the rotatable unit and reflection mirror and the compensation element to have different drives that are e.g. electronically synchronized with one another.

In another variant embodiment, the compensation element is a constituent of the drive.

Motors of any kind, for example electric motors or stepping motors, and in particular galvanometer drives, are usable as the drive.

In a preferred embodiment, the scanning microscope is a confocal scanning microscope.

### BRIEF DESCRIPTION OF THE DRAWINGS

The subject matter of the invention is schematically depicted in the drawings and will be described below with reference to the Figures, identically functioning elements being labeled with the same reference characters. In the drawings:

FIG. 1 shows a scanning microscope according to the present invention;

FIG. 2 shows a beam deflection device for a scanning microscope; and

FIG. 3 illustrates the mechanical coupling of the compensation element within a beam deflection device.

### DETAILED DESCRIPTION OF THE INVENTION

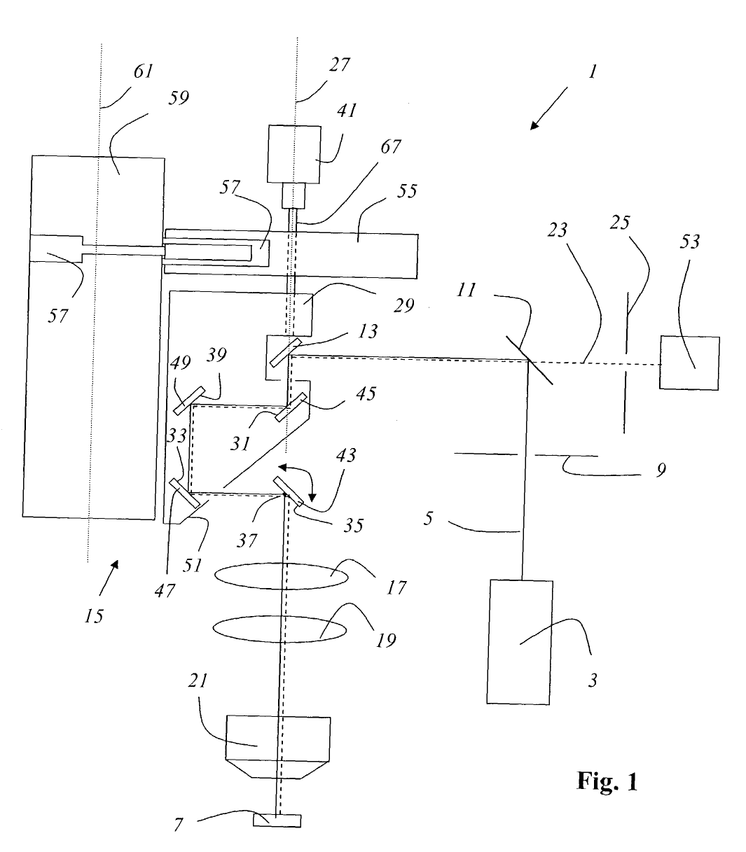

FIG. 1 shows a scanning microscope 1 according to the present invention that is embodied as a confocal scanning microscope, having a light source 3 that emits a light beam 5 for illumination of a specimen 7. Light beam 5 is focused onto an illumination pinhole 9 and is then reflected by a dichroic beam splitter 11 and a downstream reflecting mirror 13 to beam deflection device 15, which guides light beam 5 via scanning optical system 17 and tube optical system 19, through microscope optical system 21 and over or through specimen 7. Detected light beam 23 proceeding from specimen 7 travels through microscope optical system 21 and via tube optical system 19, scanning optical system 17, and beam deflection device 15 to dichroic beam splitter 11, passes through the latter and detection pinhole 25 after it, and lastly arrives at detector 53, which is embodied as a photomultiplier. In detector 53, electrical detected signals proportional to the power level of detected light beam 23 proceeding from the specimen are generated. The specimen is scanned in layers so as to generate, from the detected signals, a three-dimensional image of specimen 7.

Beam deflection device 15 contains a unit 29, rotatable about a first axis 27, which contains two reflective surfaces 31, 33 stationary with respect to one another—i.e. a first reflective surface 31 and a second reflective surface 33—and receives light beam 5 and conveys it to a third reflective surface 35 that is rotatable about a second axis 37 (perpendicular to the paper plane in the Figure) that extends perpendicular to first axis 27. In the region between reflecting mirror 13 and first reflective surface 31, light beam 5 extends along first axis 27. Rotatable unit 29 has a further reflective surface 39, stationary with respect to first reflective surface 31 and second reflective surface 33, that receives the light beam from first reflective surface 31 and reflects it to second reflective surface 33. Rotatable unit 29 is driven by a galvanometer 41. Third reflective surface 35 is deposited onto a third mirror substrate 43; the substrate is driven by a galvanometer (not shown in the Figure). First reflective surface 31 is deposited on a first mirror substrate 45, second reflective surface 33 on a second mirror substrate 47, and further reflective surface 39 on a further mirror substrate 49. Rotatable unit 29 has a housing 51 that encloses the reflective surfaces and protects them from contamination. Certain optical elements for guiding and shaping the light beams are omitted from the Figure in the interest of better clarity. These are sufficiently familiar to the person skilled in this art.

Galvanometer 41 pivots rotatable unit 29 about first axis 27. Energy transfer is accomplished via a drive shaft 67. Mounted on drive shaft 67 is an entrainment disk 55 that is coupled via a flat flexible belt 57 to compensation element 59 in such a way that the latter pivots about a third axis 61 in the opposite direction from rotatable unit 29. Compensation element 59 is a cylinder that has the same moment of inertia with respect to third axis 61 that rotatable unit 29, including the other moving components, has with respect to first axis 27. Galvanometer 41 could also be arranged so that it primarily drives compensation element 59, and so that rotatable unit 29 is driven via the entrainment disk.

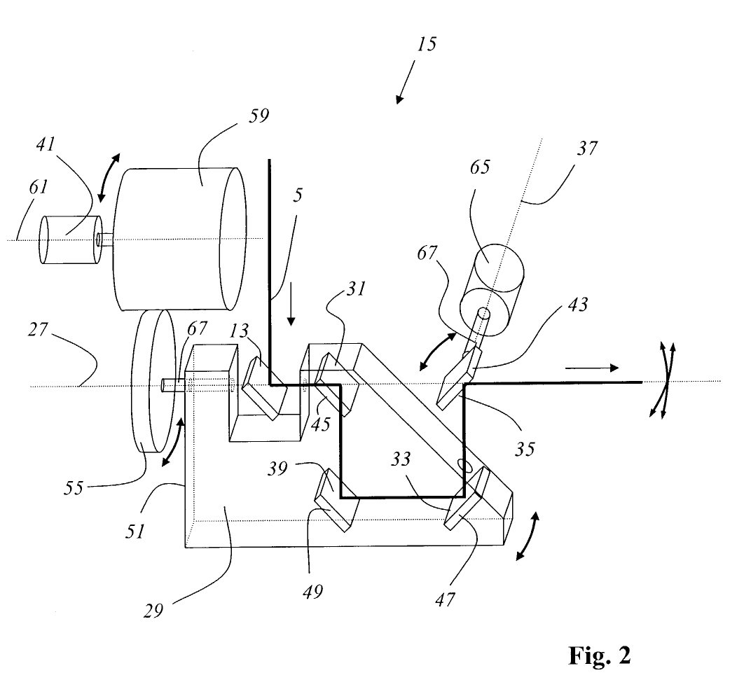

FIG. 2 is a perspective view of a beam deflection device 15 for a scanning microscope. Beam deflection device 15 contains a unit 29, rotatable about a first axis 27, which contains two reflective surfaces 31, 33 stationary with respect to one another—i.e. a first reflective surface 31 and a second reflective surface 33 and receives light beam 5 and conveys it to a third reflective surface 35 that is rotatable about a second axis 37 that extends perpendicular to first axis 27. Rotatable unit 29 has a further reflective surface 39, stationary with respect to first reflective surface 31 and second reflective surface 33, that receives the light beam from first reflective surface 31 and reflects it to second reflective surface 33. Third reflective surface 35 is deposited onto a third mirror substrate 43; the substrate is driven by a resonant galvanometer 65 via a further drive shaft 67. First reflective surface 31 is deposited on a first mirror substrate 45, second reflective surface 33 on a second mirror substrate 47, and further reflective surface 39 on a further mirror substrate 49. Rotatable unit 29 has a housing 51 that encloses the reflective surfaces and protects them from contamination. A reflecting mirror 13 that reflects light beam 5 onto first rotation axis 27 is additionally provided.

Rotatable unit 29 is driven indirectly. A galvanometer 41 pivots a compensation element 59 that is mechanically coupled, via a flat flexible belt (not shown in this Figure) and an entrainment disk 55 and a drive shaft 67, to rotatable unit 29 in such a way that the latter pivots in the opposite direction from compensation element 59. The rotation pulses of the pivoting components are thereby largely compensated for, so that almost no drive energy is transferred to the surrounding scanning microscope.

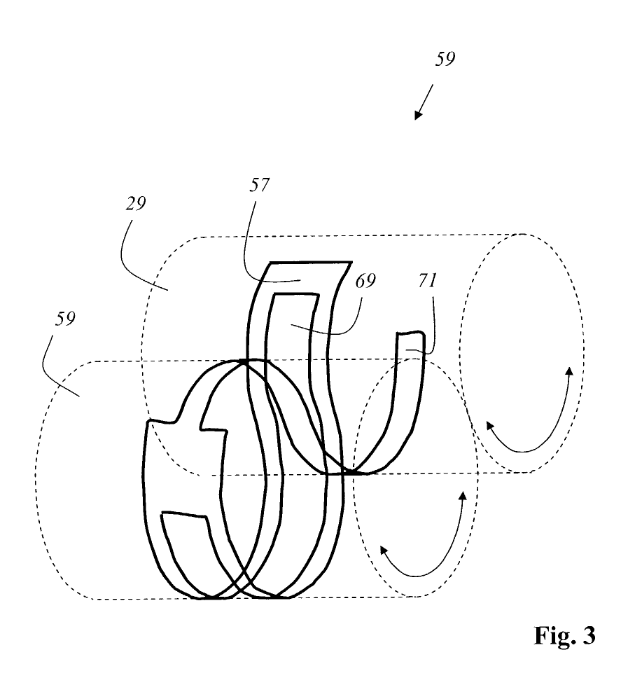

FIG. 3 illustrates one possibility for mechanically coupling compensation element 59 to rotatable unit 29 within a beam deflection device 15 using a flat belt 57 that has at one end, in the central region, a slit 69 through which the tapered other end 71 is guided. Belt 57 wraps around compensation element 59 and at its ends is placed around rotatable unit 29 (or around an entrainment disk coupled thereto) and attached to it. A particularly low-backlash coupling is thereby obtained.

The invention has been described with reference to a particular exemplary embodiment. It is self-evident, however, that changes and modifications can be made without thereby leaving the range of protection of the claims below.

What is claimed is:

1. A scanning microscope comprising:
a light source that generates a light beam for illumination of a specimen;
a beam deflection device with which the light beam can be guided over the specimen, the beam deflection device containing at least one rotatable unit having at least one reflecting mirror; and
a compensation element that executes a motion equal and opposite to that of the rotatable unit which is arranged in such a way that it at least partially compensates for the moment of inertia of the rotatable unit.

2. The scanning microscope as defined in claim 1, wherein the compensation element at least partially compensates for the moments of inertia of further movable components.

3. The scanning microscope as defined in claim 1, wherein the reflecting minor is tiltable and/or pivotable about a first axis.

4. The scanning microscope as defined in claim 3, wherein the compensation element is rotatable about a second axis that is parallel to the first axis.

5. The scanning microscope as defined in claim 3, wherein the compensation element is rotatable about a third axis that is parallel to the first axis.

6. The scanning microscope as defined in claim 4, wherein the compensation element and the rotatable unit are mechanically coupled to one another with at least one belt that transfers drive energy.

7. The scanning microscope as defined in claim 5, wherein the compensation element and the rotatable unit are mechanically coupled to one another with at least one belt that transfers drive energy.

8. The scanning microscope as defined in claim 1, wherein a drive drives the beam deflection device.

9. The scanning microscope as defined in claim 8, wherein the drive also drives the compensation element.

10. The scanning microscope as defined in claim 8, wherein the compensation element is a constituent of the drive.

11. The scanning microscope as defined in claim 8, wherein the drive is a galvanometer.

12. The scanning microscope as defined in claim 8, wherein the compensation element has a further drive that is synchronized with the drive of the beam deflection device.

13. A confocal scanning microscope comprising:
a light source that generates a light beam for illumination of a specimen;
a beam deflection device with which the light beam can be guided over the specimen, the beam deflection device containing at least one rotatable unit having at least one reflecting mirror; and
a compensation element that executes a motion equal and opposite to that of the rotatable unit which is arranged in such a way that it at least partially compensates for the moment of inertia of the rotatable unit.

14. The confocal scanning microscope as defined in claim 13, wherein the compensation element at least partially compensates for the moments of inertia of further movable components.

15. The confocal scanning microscope as defined in claim 13, wherein the reflecting mirror is tiltable and/or pivotable about a first axis.

16. The confocal scanning microscope as defined in claim 15, wherein the compensation element is rotatable about a second axis that is parallel to the first axis.

17. A beam deflection device for a scanning microscope with which a light beam can be guided over a specimen, the beam deflection device comprising: at least one rotatable unit having at least one reflecting mirror, a compensation element that executes a motion equal and opposite to that of the rotatable unit is arranged in such a way that it at least partially compensates for the moment of inertia of the rotatable unit.

18. The beam deflection device as defined in claim 17, wherein the compensation element at least partially compensates for the moments of inertia of further movable components.
